(19) United States
(12) Patent Application Publication
(10) Pub. No.: US 2019/0063332 A1
(43) Pub. Date: Feb. 28, 2019

(54) SYSTEMS AND METHODS FOR NOX PREDICTION IN A POWER PLANT

(71) Applicant: General Electric Company, Schenectady, NY (US)

(72) Inventors: Brian James Whitright, Greenville, SC (US); Robert Loeven, Greenville, SC (US)

(73) Assignee: General Electric Company, Schenectady, NY (US)

(21) Appl. No.: 15/683,158

(22) Filed: Aug. 22, 2017

(51) Int. Cl. F02C 9/24; F23N 5/00

(52) U.S. Cl. CPC F02C 9/24; F23N 5/003

(57) ABSTRACT

Systems and methods for NOx prediction in a power plant are disclosed. According to one embodiment of the disclosure, a method for NOx prediction in a power plant can be provided. The method may include receiving parameters associated with operation of a combined gas turbine and steam turbine in a power plant, wherein the parameters comprise a combined power output value; determining a steam turbine power output value; based at least in part on the steam turbine power output value, estimating a gas turbine power output value. The method may further include: based at least in part on an input matrix, determining a set of modeled gas turbine parameters. The method may further include based at least in part on omission of the estimated gas turbine power output value from the input matrix, determining a modified set of modeled gas turbine parameters; based at least in part on the modified set of modeled parameters, determining a NOx emission value associated with the power plant; based at least in part on the NOx emission value, determining a control action for the power plant; and facilitating the control action for the power plant.

### TECHNICAL FIELD

Embodiments of this disclosure generally relate to power plant systems, and more specifically, to systems and methods for NOx prediction in a power plant.

### BACKGROUND

A power plant system can include one or more turbines, such as, for example, a gas turbine and a steam turbine. A power plant system may either be in a single shaft configuration or in a multi-shaft configuration. A single shaft configuration, such as a combined cycle power plant, may include a gas turbine, a steam turbine, and a generator on a common shaft. In such a power plant, a power output from the gas turbine can be estimated based on a measured combined output from the generator. However, tuning the power plant based on the operating parameters received from the various components can often be difficult since reducing emissions, such as nitrogen oxides (NOx), is usually balanced with reducing adverse combustion dynamics.

### BRIEF DESCRIPTION OF THE DISCLOSURE

Some or all of the above needs and/or problems may be addressed by certain embodiments of the disclosure. Certain embodiments may include systems and methods for NOx prediction in a power plant. According to one embodiment of the disclosure, a method for NOx prediction in a power plant can be provided. The method may include receiving parameters associated with operation of a combined gas turbine and steam turbine in a power plant, wherein the parameters comprise a combined power output value; determining a steam turbine power output value; based at least in part on the steam turbine power output value, estimating a gas turbine power output value. The method may further include: based at least in part on an input matrix, determining a set of modeled gas turbine parameters. The method may further include based at least in part on omission of the estimated gas turbine power output value from the input matrix, determining a modified set of modeled gas turbine parameters; based at least in part on the modified set of modeled parameters, determining a NOx emission value associated with the power plant; based at least in part on the NOx emission value, determining a control action for the power plant; and facilitating the control action for the power plant.

According to another embodiment of the disclosure, a system can be provided. The system can include a controller. The system can also include a memory with instructions executable by a computer for performing operations that can include: receiving parameters associated with operation of a combined gas turbine and steam turbine in a power plant, wherein the parameters comprise a combined power output value; determining a steam turbine power output value; based at least in part on the steam turbine power output value, estimating a gas turbine power output value; based at least in part on an input matrix, determining a set of modeled gas turbine parameters; based at least in part on omission of the estimated gas turbine power output value from the input matrix, determining a modified set of modeled gas turbine parameters; based at least in part on the modified set of modeled parameters, determining a NOx emission value associated with the power plant; based at least in part on the NOx emission value, determining a control action for the power plant; and facilitating the control action for the power plant.

According to another embodiment of the disclosure, a non-transitory computer-readable medium can be provided. The non-transitory computer-readable medium can include instructions executable by a computer for performing operations that can include, receiving parameters associated with operation of a combined gas turbine and steam turbine in a power plant, wherein the parameters comprise a combined power output value; determining a steam turbine power output value; based at least in part on the steam turbine power output value, estimating a gas turbine power output value; based at least in part on an input matrix, determining a set of modeled gas turbine parameters; based at least in part on omission of the estimated gas turbine power output value from the input matrix, determining a modified set of modeled gas turbine parameters; based at least in part on the modified set of modeled parameters, determining a NOx emission value associated with the power plant; based at least in part on the NOx emission value, determining a control action for the power plant; and facilitating the control action for the power plant.

Other embodiments, features, and aspects of the disclosure will become apparent from the following description taken in conjunction with the following drawings.

### BRIEF DESCRIPTION OF THE DRAWINGS

Having thus described the disclosure in general terms, reference will now be made to the accompanying drawings, which are not necessarily drawn to scale, and wherein:

FIG. 1 is a block diagram illustrating an example environment in which certain systems and methods for NOx prediction in a power plant may be implemented, in accordance with an example embodiment of the disclosure.

FIG. 2A and FIG. 2B respectively illustrate example system schematics for example implementations of systems and methods for NOx prediction in a power plant, in accordance with example embodiments of the disclosure.

FIG. 3 is a flow chart illustrating a method for NOx prediction in a power plant, according to an example embodiment of the disclosure.

FIG. 4 is an example controller in which certain systems and methods for NOx prediction in a power plant can be implemented, in accordance with an example embodiment of the disclosure.

### DETAILED DESCRIPTION

The following detailed description includes references to the accompanying drawings, which form part of the detailed description. The drawings depict illustrations, in accordance with example embodiments. These example embodiments, which are also referred to herein as “examples,” are described in enough detail to enable those skilled in the art to practice the present subject matter. The example embodiments may be combined, other embodiments may be utilized, or structural, logical, and electrical changes may be made, without departing from the scope of the claimed subject matter. The following detailed description is, therefore, not to be taken in a limiting sense, and the scope is defined by the appended claims and their equivalents. Like numbers refer to like elements throughout.

Certain embodiments described herein relate to systems and methods for NOx prediction in a power plant. For example, as will be described in greater detail herein, parameters associated with operation of a combined gas turbine and steam turbine in a power plant may be received. The parameters may include a combined power output value, or a combined megawatt (MW) value, either of which represents a combined output from the gas turbine and steam turbine operation. Output as measured in megawatts, for example, from a steam turbine may be determined based at least in part on a model of the steam turbine. Also, based at least in part on the output from a steam turbine as measured in, for example, megawatts, output from a gas turbine as measured in megawatts, for example, may be estimated. Furthermore, based at least in part on an input matrix, a set of modeled gas turbine parameters may be determined. Based at least in part on omission of the estimated gas turbine power output, or estimated gas turbine megawatts, from the input matrix, a modified set of modeled gas turbine parameters may be determined. Furthermore, based at least in part on the modified set of modeled parameters, a NOx emission value associated with the power plant may be determined. Based at least in part on the NOx emission value, a control action for the power plant may be determined. Furthermore, the control action for the power plant may be facilitated.

One or more technical effects associated with certain embodiments herein may include, but are not limited to more accurate prediction of NOx emissions, which can improve power plant operation and reliability, lower operating cost, and lead to relatively cleaner designs. The following provides a detailed description of various example embodiments related to systems and methods for NOx prediction in a power plant.

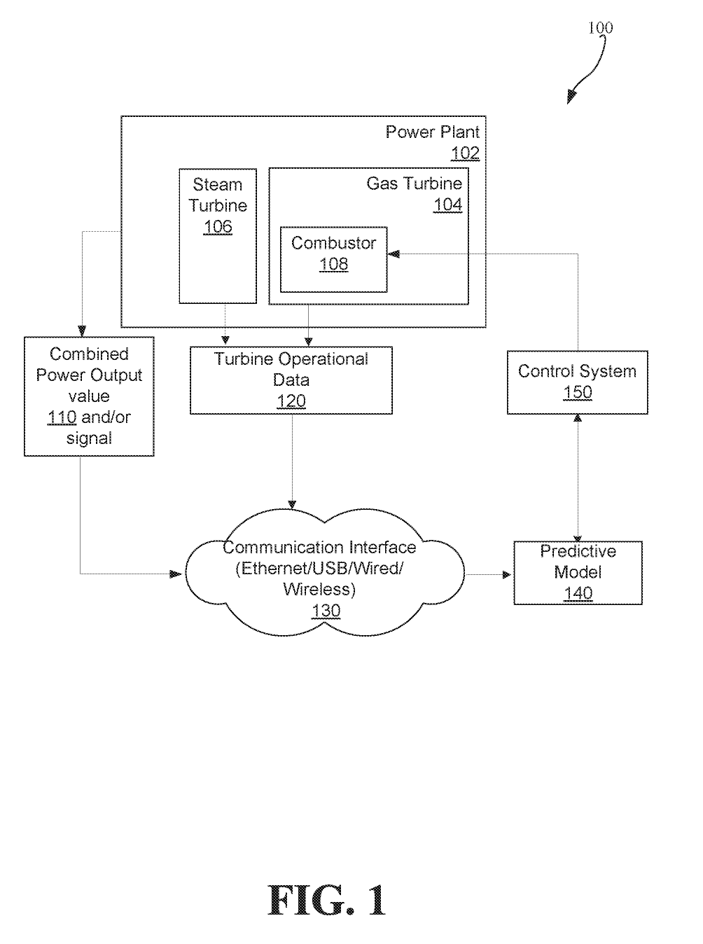

FIG. 1 depicts an example system 100 to implement certain systems and methods for NOx prediction in a power plant 102, according to an embodiment of the disclosure. The system 100 may include a power plant 102, such as, for example, a combined cycle power plant, a cogeneration power plant, and so on. The system 100 may further include a gas turbine 104 and a steam turbine 106 that may produce power. The gas turbine 104 may further include a combustor 108. The combustor 108 may receive a fuel flow and an airflow that may be mixed and ignited to produce combustion products that may be propelled through an expansion turbine (not shown). The system 100 may further include one or more controllers, such as the control system 150 of FIG. 1 that can control the gas turbine 104, the steam turbine 106 and/or the combustor 108.

The system 100, according to an embodiment of the disclosure, can generate turbine operational data 120 that may be data received from or otherwise derived from one or more sensors associated with the gas turbine 104, the steam turbine 106, and/or a generator (not shown) associated with the power plant 102. The system 100 may further generate a combined power output value 110 and/or signal representing the combined power output of the gas turbine 104 and the steam turbine 106. The combined power output value 110 and/or signal and turbine operational data 120 may be communicated from the power plant 102 via a communication interface 130 to a predictive model 140 and to the control system 150 and/or controller.

The combined power output value 110 and/or signal may represent a combined power output from the gas turbine 104 and the steam turbine 106. For example, in a single shaft combined cycle power plant, the gas turbine 104 and steam turbine 106 of FIG. 1 may be connected in series to a single generator on a single shaft. Thus, the power output of such a combined cycle plant would be the combined power output from the gas turbine 104 and the steam turbine 106, and resulting in an output measured by the combined power output value 110 and/or signal.

The turbine operational data 120 may include discrete data and time series data. For example, turbine operational data 120 may include time series data, such as operating speed, operating power, operating pressure, firing temperature, and so on. Turbine operational data 120 may also include operational hours of the combustor 110, operating time in specific modes of operation of the combustor 110, and so on.

The predictive model 140 and the control system 150 can be communicatively coupled to receive the turbine operational data 120 and combined power output value 110 and/or signal via the communication interface 130, which can be any of one or more communication networks such as, for example, an Ethernet interface, a Universal Serial Bus (USB) interface, or a wireless interface. In certain embodiments, the control system 150 can be configured to receive the turbine operational data 120 and/or combined power output value 110 and/or signal by way of a hard wire or cable, such as, for example, an interface cable.

The control system 150 and/or controller can include a computer system having one or more processors that can execute computer-executable instructions to receive and analyze data and/or signals from various data sources, such as turbine operational data 120, a combined power output value 110 and/or signal, and data and/or signals from the predictive model 140. The control system 150 and/or controller can provide inputs to any number of associated components of the power plant 102, gather transfer function outputs from any number of data sources, and transmit and/or implement control instructions from any number of operators and/or personnel as well as from computers and/or processors. The control system 150 and/or controller can perform control and/or corrective actions as well as provide inputs to the predictive model 140. In some other embodiments, the control system 150 and/or controller may determine control and/or corrective actions to be performed based on data received from one or more data sources and/or signals, for example, from the turbine operational data 120 and/or combined power output value 110 and/or signal. In other instances, the control system 150 and/or controller can be an independent entity communicatively coupled to the predictive model 140.

According to an embodiment of the disclosure, the system 100 of FIG. 1 can include a control system 150 and/or controller and a memory with computer-readable instructions that can receive parameters associated with operation of a combined gas turbine 104 and steam turbine 106 in a power plant 102, wherein the parameters can include a combined power output value 110 and/or signal. The control system 150 and/or controller can further determine a steam turbine power output value and/or signal. This determination may be performed by a model of the steam turbine 106 within the control system 150 and/or controller. The control system 150 and/or controller can further estimate a gas turbine power output value and/o signal, based at least in part on the steam turbine power output value and/or signal. According to an embodiment of the disclosure, the gas turbine power output value and/or signal may be estimated based at least in part on deducting the steam turbine power output value and/or signal from the combined power output value 110 and/or signal.

The control system 150 and/or controller can further determine a set of modeled gas turbine parameters, based at least in part on an input matrix that may include turbine parameters, such as, for example, an estimated gas turbine power output value, a discharge pressure of a compressor associated with the gas turbine 104, a discharge temperature of the compressor, and an exhaust temperature of the gas turbine 104. The determination of the set of modeled parameters may be performed by implementing a predictive algorithm in, for instance, a four (4) by four (4) calculation mode. Running the predictive algorithm in a four (4) by four (4) calculation mode may involve using a 4×4 matrix of inputs to run the predictive algorithm. The set of modeled parameters may include parameters associated with operation of the gas turbine 104 or the steam turbine 106, such as, for example, turbine firing temperature, compressor pressure ratio, turbine exhaust pressure, and so on.

In an example embodiment of the disclosure, the control system 150 and/or the controller may calculate a NOx emission associated with the gas turbine 104, based on the set of modeled gas turbine parameters as input. In some instances, the NOx emission may include errors that may be carried over from the determined steam turbine power output value and/or signal.

In another example embodiment of the disclosure, the estimated gas turbine power output value and/or signal may be omitted from the input matrix. Based at least in part on the omission of the estimated gas turbine power output value and/or signal from the input matrix, the control system 150 and/or controller may determine a modified set of modeled parameters. The modified input matrix may include at least the inputs of a discharge pressure of a compressor associated with the gas turbine 104, a discharge temperature of the compressor, and an exhaust temperature of the gas turbine 104. The determination of the modified set of modeled parameters may further include implementing the predictive algorithm in, for instance, a three (3) by three (3) calculation mode, wherein the three (3) by three (3) calculation mode degrades one or more of the modified set of modeled gas turbine parameters. The degradation of one or more of the modified set of modeled gas turbine parameters may include reducing a firing temperature of the gas turbine 104, reducing a fuel flow to the gas turbine 104, and/or reducing a pressure ratio across a compressor.

The modified set of modeled parameters may include parameters associated with operation of the gas turbine 104 or the steam turbine 106, such as, for example, turbine firing temperature, compressor pressure ratio, turbine exhaust pressure, and so on. These parameters may have different values compared to the ones determined previously by implementing the predictive algorithm in a four (4) by four (4) calculation mode. Based at least in part on the modified set of modeled parameters, the control system 150 and/or controller may determine a NOx emission value associated with the power plant 102. The determination of the NOx emission value associated with the power plant 102 may be based on a NOx prediction model. Based at least in part on the NOx emission value, the control system 150 and/or controller may determine a control action for the power plant 102. The control system 150 and/or controller may further facilitate the control action for the power plant 102.

The control action for the power plant 102 may include a closed loop control action, an open loop control action, a model based control action, and/or a model predictive control action. In an example embodiment of the disclosure, the control action may facilitate reducing NOx emission from the power plant 102. In another example embodiment of the disclosure, the control action may facilitate reducing NOx emission from the gas turbine 104.

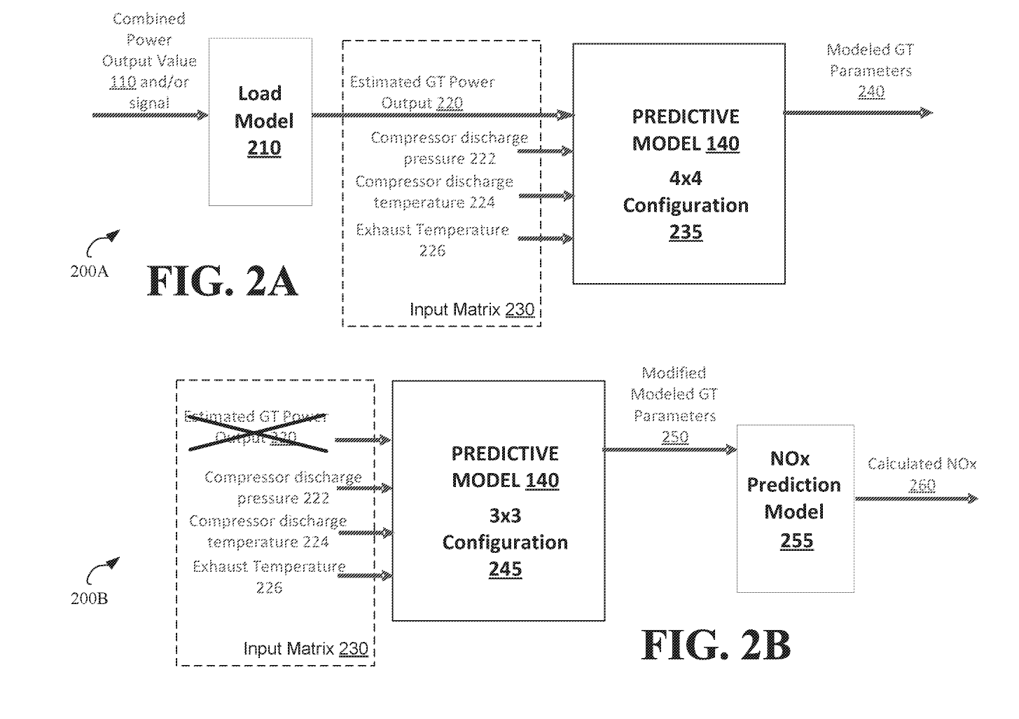

Attention is now drawn to FIG. 2A and FIG. 2B, which depict example implementations of systems and methods for NOx prediction in a power plant 102, in accordance with example embodiments of the disclosure. As shown by the flow 200A in FIG. 2A, a load model 210 may receive the combined power output signal 110. The load model 210 may include a model of the steam turbine that may determine the steam turbine power output value and/or signal. The load model 210 may also include a model that may estimate the gas turbine power output based on the steam turbine power output value and/or signal. An input matrix 230 may include the estimated gas turbine power output (Estimated GT Power Output 220) value and/or signal along with other inputs, such as, for example, compressor discharge pressure 222, compressor discharge temperature 224 and exhaust temperature 226. These parameters may be related to operating parameters of the gas turbine 104 and/or the steam turbine 106. The input matrix 230 may be fed to the predictive model 140 and the predictive model 140 may be executed in a 4×4 configuration 235 as shown in FIG. 2. The resulting modeled GT parameters 240 may be utilized in a model to estimate NOx emission value.

Attention is now drawn to FIG. 2B, in which another example embodiment of the disclosure is depicted. As shown in flow 200B, the input matrix 230 of FIG. 2A may be modified by omitting the estimated GT power output 220 input value and/or signal. The modified input matrix may then be fed to the predictive model 140 to run in a 3×3 configuration 245. The predictive model 140 may run the model in the 3×3 configuration with modified input matrix which may degrade one or more of the outputs. The degradation of one or more of the outputs may be in part due to the omission of the estimated GT power output 220 value and/or signal from the input matrix 230. The resulting modified modeled GT parameters 250 may contain parameters that are different from those in the modeled GT parameters 240. The modified modeled GT parameters 250 is then fed to a NOx prediction model 255, which may then produce a calculated NOx 260 value.

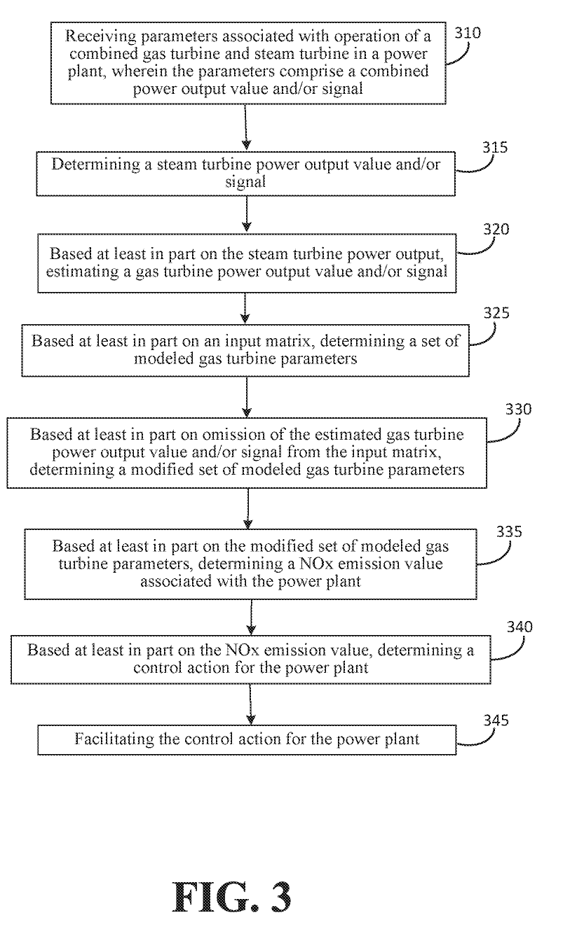

Referring now to FIG. 3, a flow diagram of an example method 300 for systems and methods for NOx prediction in a power plant 102, according to an example embodiment of the disclosure. The method 300 may be utilized in association with various systems, such as the system 100 illustrated in FIG. 1 or the respective example flows 200A and 200B of FIG. 2A and FIG. 2B respectively.

The method 300 may begin at block 310. At block 310, parameters associated with operation of a combined gas turbine 104 and steam turbine 106 in a power plant 102, wherein the parameters include a combined power output value 110 and/or signal may be received. At block 315, the method 300 may include determining a steam turbine power output value and/or signal.

At block 320, the method 300 may further include estimating a gas turbine power output value 220 and/or signal, based at least in part on the steam turbine power output value and/or signal.

At block 325, the method 300 may further include determining a set of modeled gas turbine parameters 240, based at least in part on an input matrix 230.

At block 330, the method 300 may include, based at least in part on omission of the estimated gas turbine power output value 220 and/or signal from the input matrix 230, determining a modified set of modeled gas turbine parameters 250.

Further, at block 335, the method 300 may include determining a NOx emission value 260 associated with the power plant 102, based at least in part on the modified set of modeled gas turbine parameters 250.

Further, at block 340, the method 300 may include determining a control action for the power plant 102, based at least in part on the NOx emission value 260.

Finally, at block 345, the method 300 may include facilitating the control action for the power plant 102.

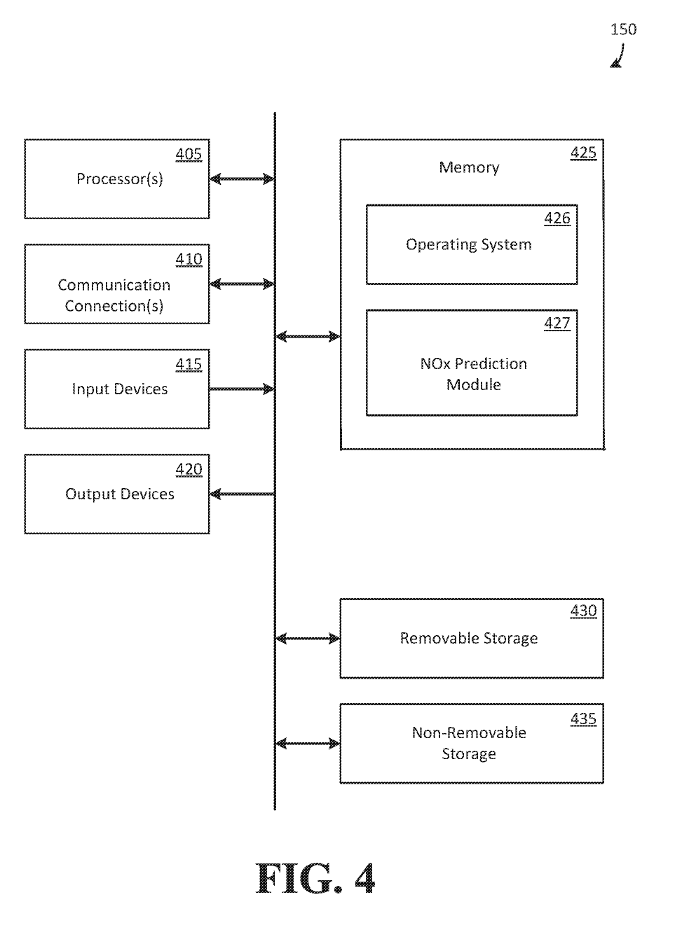

Attention is now drawn to FIG. 4, which illustrates an example control system 150 and/or controller configured for implementing certain systems and methods for systems and methods for NOx prediction in a power plant 102, in accordance with certain embodiments of the disclosure. The control system 150 and/or controller can include a processor 405 for executing certain operational aspects associated with implementing certain systems and methods for systems and methods for NOx prediction in a power plant 102 in accordance with certain embodiments of the disclosure. The processor 405 can be capable of communicating with a memory 425. The processor 405 can be implemented and operated using appropriate hardware, software, firmware, or combinations thereof. Software or firmware implementations can include computer-executable or machine-executable instructions written in any suitable programming language to perform the various functions described. In one embodiment, instructions associated with a functional block language can be stored in the memory 425 and executed by the processor 405.

The memory 425 can be used to store program instructions that are loadable and executable by the processor 405 as well as to store data generated during the execution of these programs. Depending on the configuration and type of the control system 150 and/or controller, the memory 425 can be volatile (such as random access memory (RAM)) and/or non-volatile (such as read-only memory (ROM), flash memory, etc.). In some embodiments, the memory devices can also include additional removable storage 430 and/or non-removable storage 435 including, but not limited to, magnetic storage, optical disks, and/or tape storage. The disk drives and their associated computer-readable media can provide non-volatile storage of computer-readable instructions, data structures, program modules, and other data for the devices. In some implementations, the memory 425 can include multiple different types of memory, such as static random access memory (SRAM), dynamic random access memory (DRAM), or ROM.

The memory 425, the removable storage 430, and the non-removable storage 435 are all examples of computer-readable storage media. For example, computer-readable storage media can include volatile and non-volatile, removable and non-removable media implemented in any method or technology for storage of information such as computer-readable instructions, data structures, program modules or other data. Additional types of computer storage media that can be present include, but are not limited to, programmable random access memory (PRAM), SRAM, DRAM, RAM, ROM, electrically erasable programmable read-only memory (EEPROM), flash memory or other memory technology, compact disc read-only memory (CD-ROM), digital versatile discs (DVD) or other optical storage, magnetic cassettes, magnetic tapes, magnetic disk storage or other magnetic storage devices, or any other medium which can be used to store the desired information and which can be accessed by the devices. Combinations of any of the above should also be included within the scope of computer-readable media.

The control system 150 and/or controller can also include one or more communication connections 410 that can allow a control device (not shown) to communicate with devices or equipment capable of communicating with the control system 150 and/or controller. The control system 150 and/or controller can also include a computer system (not shown). Connections can also be established via various data communication channels or ports, such as USB or COM ports to receive cables connecting the control system 150 and/or controller to various other devices on a network. In one embodiment, the control system 150 and/or controller can include Ethernet drivers that enable the control system 150 and/or controller to communicate with other devices on the network. According to various embodiments, communication connections 410 can be established via a wired and/or wireless connection on the network.

The control system 150 and/or controller can also include one or more input devices 415, such as a keyboard, mouse, pen, voice input device, gesture input device, and/or touch input device. It can further include one or more output devices 420, such as a display, printer, and/or speakers.

In other embodiments, however, computer-readable communication media can include non-transitory computer readable media, computer-readable instructions, program modules, or other data transmitted within a data signal, such as a carrier wave, or other transmission. As used herein, however, computer-readable storage media do not include computer-readable communication media.

Turning to the contents of the memory 425, the memory 425 can include, but may not be limited to, an operating system (OS) 426 and one or more application programs or services for implementing the features and aspects disclosed herein. Such applications or services can include a NOx prediction module 427 for executing certain systems and methods for NOx prediction in a power plant 102. The NOx prediction module 427 can reside in the memory 425 or can be independent of the control system 150 and/or controller. In one embodiment, the NOx prediction module 427 can be implemented by software that can be provided in configurable control block language and can be stored in non-volatile memory. When executed by the processor 405, the NOx prediction module 427 can implement the various functionalities and features associated with the control system 150 and/or controller described in this disclosure.

As desired, embodiments of the disclosure may include a control system 150 and/or controller with more or fewer components than are illustrated in FIG. 4. Additionally, certain components of the control system 150 and/or controller may be combined in various embodiments of the disclosure. The control system 150 and/or controller of FIG. 4 is provided by way of example only.

References are made to block diagrams of systems, methods, apparatuses, and computer program products according to example embodiments. It will be understood that at least some of the blocks of the block diagrams, and combinations of blocks in the block diagrams, may be implemented at least partially by computer program instructions. These computer program instructions may be loaded onto a general purpose computer, special purpose computer, special purpose hardware-based computer, or other programmable data processing apparatus to produce a machine, such that the instructions which execute on the computer or other programmable data processing apparatus create means for implementing the functionality of at least some of the blocks of the block diagrams, or combinations of blocks in the block diagrams discussed.

These computer program instructions may also be stored in a non-transitory computer-readable memory that can direct a computer or other programmable data processing apparatus to function in a particular manner, such that the instructions stored in the computer-readable memory produce an article of manufacture including instruction means that implement the function specified in the block or blocks. The computer program instructions may also be loaded onto a computer or other programmable data processing apparatus to cause a series of operations and/or operational acts to be performed on the computer or other programmable apparatus to produce a computer implemented process such that the instructions that execute on the computer or other programmable apparatus provide task, acts, actions, or operations for implementing the functions specified in the block or blocks.

One or more components of the systems and one or more elements of the methods described herein may be implemented through an application program running on an operating system of a computer. They also may be practiced with other computer system configurations, including hand-held devices, multiprocessor systems, microprocessor based or programmable consumer electronics, mini-computers, mainframe computers, and the like.

Application programs that are components of the systems and methods described herein may include routines, programs, components, data structures, and so forth that implement certain abstract data types and perform certain tasks or actions. In a distributed computing environment, the application program (in whole or in part) may be located in local memory or in other storage. In addition, or alternatively, the application program (in whole or in part) may be located in remote memory or in storage to allow for circumstances where tasks may be performed by remote processing devices linked through a communications network.

Many modifications and other embodiments of the example descriptions set forth herein to which these descriptions pertain will come to mind having the benefit of the teachings presented in the foregoing descriptions and the associated drawings. Thus, it will be appreciated that the disclosure may be embodied in many forms and should not be limited to the example embodiments described above.

Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

The claimed disclosure is:

1. A method comprising:
receiving parameters associated with operation of a combined gas turbine and steam turbine in a power plant, wherein the parameters comprise a combined power output value;
determining a steam turbine power output value;
based at least in part on the steam turbine power output value, estimating a gas turbine power output value;
based at least in part on an input matrix, determining a set of modeled gas turbine parameters;
based at least in part on omission of the estimated gas turbine power output value from the input matrix, determining a modified set of modeled gas turbine parameters;
based at least in part on the modified set of modeled gas turbine parameters, determining a NOx emission value associated with the power plant;
based at least in part on the NOx emission value, determining a control action for the power plant; and
facilitating the control action for the power plant.

2. The method of claim 1, wherein the input matrix comprises at least one of the following: gas turbine power output value, discharge pressure of a compressor associated with the gas turbine, discharge temperature of the compressor, and exhaust temperature of the gas turbine.

3. The method of claim 1, wherein determining a set of modeled gas turbine parameters comprises:
implementing a predictive algorithm in a four (4) by four (4) calculation mode.

4. The method of claim 1, wherein determining a modified set of modeled gas turbine parameters comprises:
implementing a predictive algorithm in a three (3) by three (3) calculation mode, wherein the three (3) by three (3) calculation mode degrades one or more of the modified set of modeled gas turbine parameters.

5. The method of claim 1, wherein determining a NOx emission value comprises:
implementing a NOx prediction model.

6. The method of claim 1, wherein the control action for the power plant comprises at least one of the following:
a closed loop control action, an open loop control action, a model based control action, and a model predictive control action.

7. The method of claim 4, wherein the one or more of the modified set of modeled gas turbine parameters is degraded by at least one of:
reducing a firing temperature of the gas turbine, reducing a fuel flow to the gas turbine, and reducing a pressure ratio across a compressor.

8. A system comprising:
a controller; and
a memory comprising computer-executable instructions operable to:
receive parameters associated with operation of a combined gas turbine and steam turbine in a power plant, wherein the parameters comprise a combined power output value;
determine a steam turbine power output value;
based at least in part on the steam turbine power output value, estimate a gas turbine power output value;
based at least in part on an input matrix, determine a set of modeled gas turbine parameters;
based at least in part on omission of the estimated gas turbine power output value from the input matrix, determine a modified set of modeled gas turbine parameters;
based at least in part on the modified set of modeled parameters, determine a NOx emission value associated with the power plant;
based at least in part on the NOx emission value, determine a control action for the power plant; and
facilitate the control action for the power plant.

9. The system of claim 8, wherein the input matrix comprises at least one of the following: gas turbine power output value, a discharge pressure of a compressor associated with the gas turbine, a discharge temperature of a compressor, and an exhaust temperature of the gas turbine.

10. The system of claim 8, wherein the computer-executable instructions operable to determine a set of modeled gas turbine parameters are further operable to:
implement a predictive algorithm in a four (4) by four (4) calculation mode.

11. The system of claim 8, wherein the computer-executable instructions operable to determine a modified set of modeled gas turbine parameters are further operable to:
implement the predictive algorithm in a three (3) by three (3) calculation mode, wherein the three (3) by three (3) calculation mode degrades one or more of the modified set of modeled gas turbine parameters.

12. The system of claim 8, wherein the computer-executable instructions operable to determine the NOx emission value are further operable to:
implement a NOx prediction model.

13. The system of claim 8, wherein the control action for the power plant comprises at least one of the following:
a closed loop control action, an open loop control action, a model based control action, and a model predictive control action.

14. The system of claim 11, wherein the computer-executable instructions operable to degrade one or more of the modified set of modeled gas turbine parameters comprises at least one of:
reducing a firing temperature of the gas turbine, reducing a fuel flow to the gas turbine, and reducing a pressure ratio across a compressor.

15. A non-transitory computer-readable medium comprising instructions executable by a computer for performing operations comprising:
receiving parameters associated with operation of a combined gas turbine and steam turbine in a power plant, wherein the parameters comprise a combined power output value;
determining a steam turbine power output value;
based at least in part on the steam turbine power output value, estimating a gas turbine power output value;
based at least in part on an input matrix, determining a set of modeled gas turbine parameters;
based at least in part on omission of the estimated gas turbine power output value from the input matrix, determining a modified set of modeled gas turbine parameters;
based at least in part on the modified set of modeled parameters, determining a NOx emission value associated with the power plant;
based at least in part on the NOx emission value, determining a control action for the power plant; and
facilitating the control action for the power plant.

16. The computer-readable medium of claim 15, wherein the input matrix comprises at least one of the following: gas turbine power output value, a discharge pressure of a compressor associated with the gas turbine, a discharge temperature of the compressor, and an exhaust temperature of the gas turbine.

17. The computer-readable medium of claim 15, wherein determining a set of modeled gas turbine parameters comprises:
implementing a predictive algorithm in a four (4) by four (4) calculation mode.

18. The computer-readable medium of claim 15, wherein determining a modified set of modeled gas turbine parameters comprises:
implementing a predictive algorithm in a three (3) by three (3) calculation mode, wherein the three (3) by three (3) calculation mode degrades one or more of the modified set of modeled parameters;

19. The computer-readable medium of claim 15, wherein determining the NOx emission value comprises:
implementing a NOx prediction model.

20. The computer-readable medium of claim 18, wherein degrading one or more of the modified set of modeled gas turbine parameters comprises at least one of the following:
reducing a firing temperature of the gas turbine, reducing a fuel flow to the gas turbine, and reducing a pressure ratio across a compressor.
